(19) United States
(12) Patent Application Publication
(10) Pub. No.: US 2012/0139686 A1
(43) Pub. Date: Jun. 7, 2012

(54) MAGNETIC DEVICE AND ASSEMBLING METHOD THEREOF

(75) Inventor: Kretschmann Christoph, Samutprakarn (TH)

(73) Assignee: DELTA ELECTRONICS (THAILAND) PUBLIC CO., LTD., Samutprakarn (TH)

(21) Appl. No.: 13/086,201

(22) Filed: Apr. 13, 2011

(30) Foreign Application Priority Data
Dec. 6, 2010 (TW) 099142484

(51) Int. Cl. H01F 27/24; H01F 7/06; H01F 27/28

(52) U.S. Cl. 336/221; 29/606

(57) ABSTRACT

A magnetic device includes a magnetic core assembly and at least one conductive winding assembly. The magnetic core assembly includes a first magnetic core and a second magnetic core. The first magnetic core includes a first magnetic slab, a first lateral post and a second lateral post. The first lateral post and the second lateral post are disposed on opposite sides of the first magnetic slab so that an accommodating space is collectively defined by the first magnetic slab, the first lateral post and the second lateral post. The second magnetic core includes a second magnetic slab and a middle post. The middle post is attached on the second magnetic slab, and received within the accommodating space of the first magnetic core. The at least one conductive winding assembly is directly wound around the middle post of the second magnetic core.

### FIELD OF THE INVENTION

The present invention relates to a magnetic device, and more particularly to a magnetic device with no bobbin. The present invention also relates to a process of assembling such a magnetic device.

### BACKGROUND OF THE INVENTION

Nowadays, magnetic devices such as inductors and transformers are widely used in various electronic devices to generate induced magnetic fluxes. Since the electronic device is developed to have small size and enhanced performance, the integration density of the electronic components within the electronic device is increased and the layout space is gradually reduced. Therefore, it is critical to design a small-sized magnetic device without impairing the performance and increasing the fabricating cost.

Take a transformer for example. FIG. 1 is a schematic exploded view illustrating a conventional transformer. The conventional transformer 1 comprises a bobbin 11, a magnetic core assembly 12 and a coil 13. The bobbin 11 has a winding section 111. The coil 13 is wound around the winding section 111. The bobbin 11 has a channel 112 running through the bobbin. In addition, the magnetic core assembly 12 is an EE-type magnetic core assembly. The magnetic core assembly 12 comprises a first magnetic core 121 and a second magnetic core 122. The first magnetic core 121 comprises a middle post 121a and two lateral posts 121b. The second magnetic core 122 comprises a middle post 122a and two lateral posts 122b.

For assembling the magnetic device 1, the middle post 121a of the first magnetic core 121 and the middle post 122a of the second magnetic core 122 are embedded into the channel 112 of the bobbin 11, and the lateral posts 121b of the first magnetic core 121 are aligned with respective lateral posts 122b of the second magnetic core 122. Due to the electromagnetic induction between the coil 13, the first magnetic core 121 and the second magnetic core 122, an induction voltage is generated by the coil 13.

Since the conventional magnetic device 1 uses the EE-type magnetic core assembly, the coil 13 fails to be directly wound around the middle post 121a of the first magnetic core 121 or the middle post 122a of the second magnetic core 122 by the winding machine. In other words, the bobbin 11 is indispensable to the conventional magnetic device 1. After the coil 13 is wound around the bobbin 11, the bobbin 11 and the magnetic core assembly 12 are combined together to assemble the magnetic device 1. However, the use of the bobbin may increase the fabricating cost, increase the assembling difficulty and decrease the heat-dissipating efficiency. Moreover, since the volume of the bobbin is very bulky, the coil turn of the magnetic device is low and the window utilization is insufficient.

### SUMMARY OF THE INVENTION

The present invention provides a magnetic device and a process of assembling such a magnetic device, in which the conductive winding assembly can be directly wound around the magnetic core assembly by a winding machine. Since no bobbin is required, the magnetic device has reduced fabricating cost, simplified assembling process, enhanced heat-dissipating efficiency, increased coil turn, and enhanced window utilization.

In accordance with an aspect of the present invention, there is provided a magnetic device. The magnetic device includes a magnetic core assembly and at least one conductive winding assembly. The magnetic core assembly includes a first magnetic core and a second magnetic core. The first magnetic core includes a first magnetic slab, a first lateral post and a second lateral post. The first lateral post and the second lateral post are disposed on opposite sides of the first magnetic slab so that an accommodating space is defined by the first magnetic slab, the first lateral post and the second lateral post. The second magnetic core includes a second magnetic slab and a middle post. The middle post is attached on the second magnetic slab, and received within the accommodating space of the first magnetic core. The at least one conductive winding assembly is directly wound around the middle post of the second magnetic core.

In accordance with another aspect of the present invention, there is provided a process of assembling a magnetic device. Firstly, a magnetic core assembly including a first magnetic core and a second magnetic core is provided. The first magnetic core comprises a first magnetic slab, a first lateral post and a second lateral post, and the second magnetic core comprises a second magnetic slab and a middle post. Then, at least one conductive winding assembly is directly wound around the middle post of the second magnetic core. Afterwards, the first magnetic core is combined with the second magnetic core such that the middle post of the second magnetic core is received within an accommodating space between the first lateral post and the second lateral post of the first magnetic core.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic exploded view illustrating a conventional transformer;

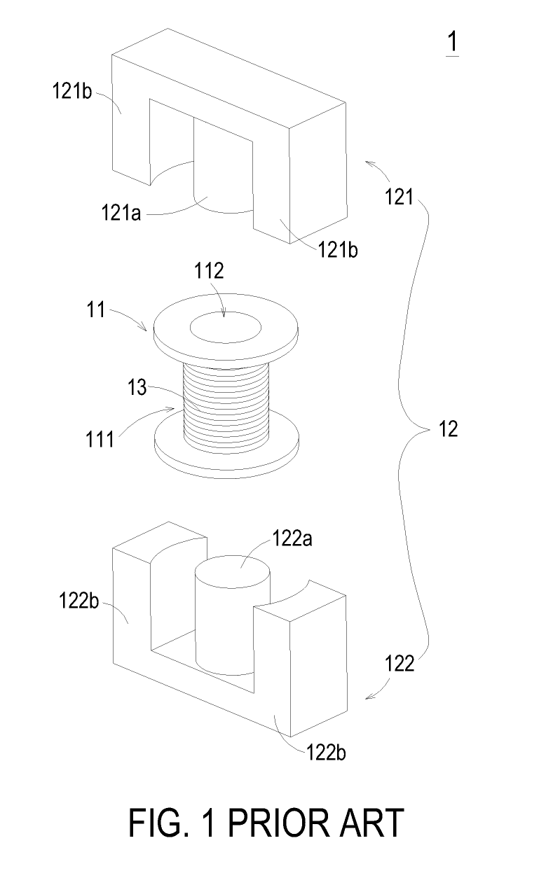

FIG. 2A is a schematic perspective view illustrating a magnetic device according to an embodiment of the present invention;

FIG. 2B is a schematic exploded view illustrating the magnetic core assembly of the magnetic device of FIG. 2A;

FIG. 2C is a schematic exploded view illustrating the magnetic core assembly of the magnetic device of FIG. 2A and taken from another viewpoint;

FIG. 2D is a schematic assembled view illustrating the magnetic core assembly of FIG. 2B;

FIG. 2E is a schematic cross-sectional view illustrating the magnetic core assembly of FIG. 2D and taken along the cross section A;

FIG. 3A is a schematic perspective view illustrating a magnetic device according to another embodiment of the present invention;

FIG. 3B is a schematic perspective view illustrating the heat sink of the magnetic device of FIG. 3A; and

FIG. 4 is a flowchart illustrating a process of assembling a magnetic device according to an embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

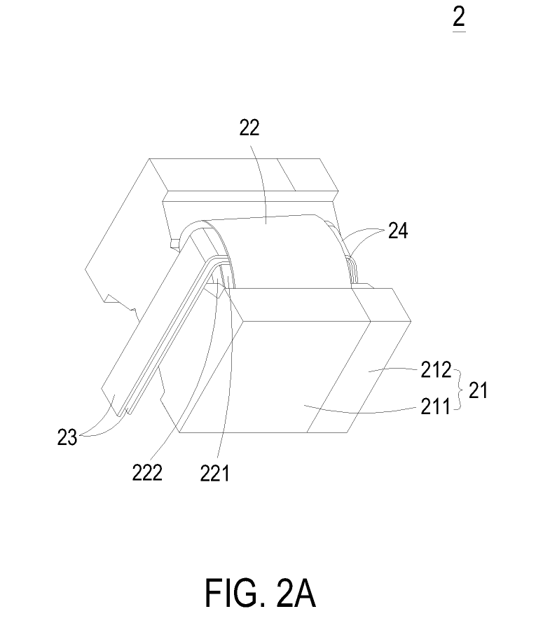

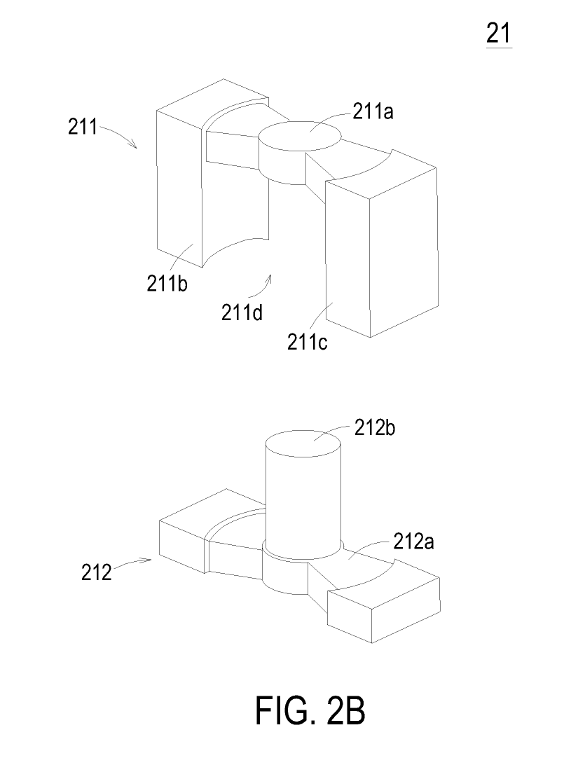

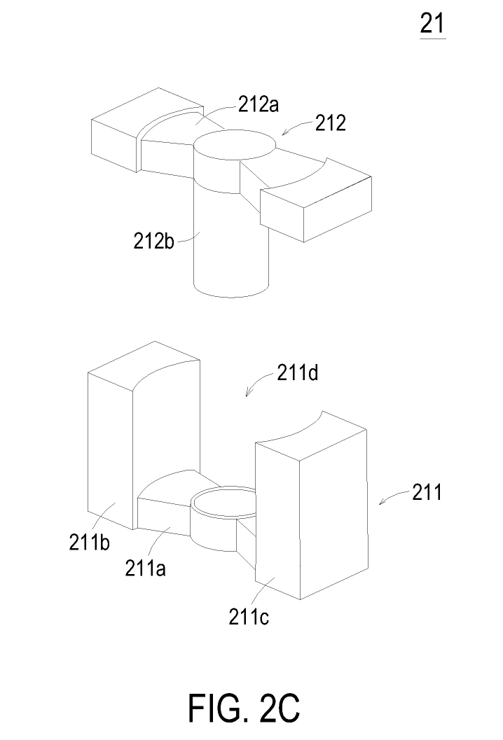

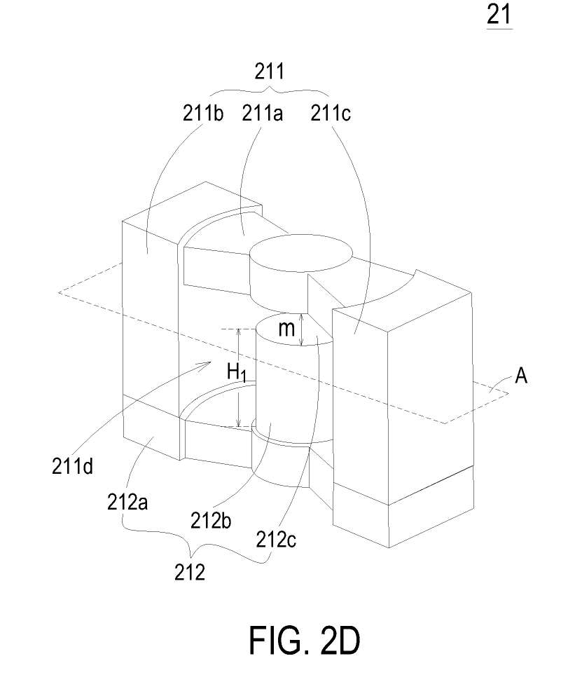

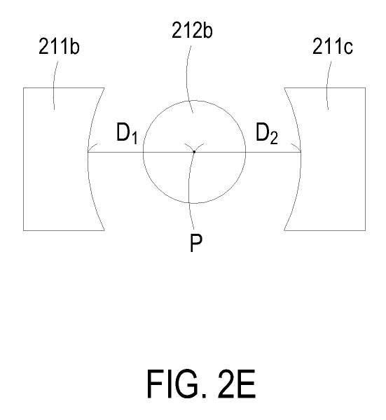

FIG. 2A is a schematic perspective view illustrating a magnetic device according to an embodiment of the present invention. FIG. 2B is a schematic exploded view illustrating the magnetic core assembly of the magnetic device of FIG. 2A. FIG. 2C is a schematic exploded view illustrating the magnetic core assembly of the magnetic device of FIG. 2A and taken from another viewpoint. The magnetic device 2 is for example a transformer. The transformer 2 comprises a magnetic core assembly 21 and plural conductive winding assemblies 22. The magnetic core assembly 21 comprises a first magnetic core 211 and a second magnetic core 212. The first magnetic core 211 comprises a first magnetic slab 211a, a first lateral post 211b and a second lateral post 211c. The first lateral post 211b and the second lateral post 211c are disposed on opposite sides of the first magnetic slab 211a. As such, an accommodating space 211d is defined by the first magnetic slab 211a, the first lateral post 211b and the second lateral post 211c. The second magnetic core 212 comprises a second magnetic slab 212a and a middle post 212b. The middle post 212b is attached on the second magnetic slab 212a, and received within the accommodating space 211d of the first magnetic core 211. The plural conductive winding assemblies 22 are directly wound around the middle post 212b of the second magnetic core 212. In addition, the plural conductive winding assemblies 22 include at least one primary conductive winding assembly 221 and at least one secondary conductive winding assembly 222. In this embodiment, the plural conductive winding assemblies 22 are made of copper foil.

In this embodiment, the first magnetic slab 211a, the first lateral post 211b and the second lateral post 211c of the first magnetic core 211 are integrally formed. In addition, the second magnetic slab 212a and the middle post 212b of the second magnetic core 212 are integrally formed. It is preferred that the first magnetic slab 211a of the first magnetic core 211 and the second magnetic slab 212a of the second magnetic core 212 are fan-shaped slabs. It is preferred that the middle post 212b of the second magnetic core 212 is a cylindrical post. In this embodiment, the first magnetic core 211 is U-shaped, and the second magnetic core 212 is T-shaped.

Please refer to FIGS. 2A, 2B and 2C again. The primary conductive winding assembly 221 and the secondary conductive winding assembly 222 of the transformer 2 are insulated from each other and wound around the middle post 212b of the second magnetic core 212. The transformer 2 further comprises a first set of pins 23 and a second set of pins 24. The first set of pins 23 are connected with the primary conductive winding assembly 221. The second set of pins 24 are connected with the secondary conductive winding assembly 222.

FIG. 2D is a schematic assembled view illustrating the magnetic core assembly of FIG. 2B. FIG. 2E is a schematic cross-sectional view illustrating the magnetic core assembly of FIG. 2D and taken along the cross section A. The middle post 212b of the second magnetic core 212 has a centerline P. The centerline P is separated from the first lateral post 211b by a first distance D1. The centerline P is separated from the second lateral post 211c by a second distance D2. The first distance D1 is substantially equal to the second distance D2, i.e. D1=D2. After the first magnetic core 211 and the second magnetic core 212 are combined together, the free end surface 212c of the middle post 212b of the second magnetic core 212 is separated from the first magnetic slab 211a of the first magnetic core 211 by an air gap distance m. The air gap distance m is varied according to the length H1 of the middle post 212b. The air gap distance m may be used to adjust the magnetic coupling effect or the leakage inductance. In some embodiments, after the first magnetic core 211 and the second magnetic core 212 are combined together, the free end surface 212c of the middle post 212b of the second magnetic core 212 is contacted with the first magnetic slab 211a of the first magnetic core 211. Under this circumstance, no air gap is formed in the magnetic core assembly.

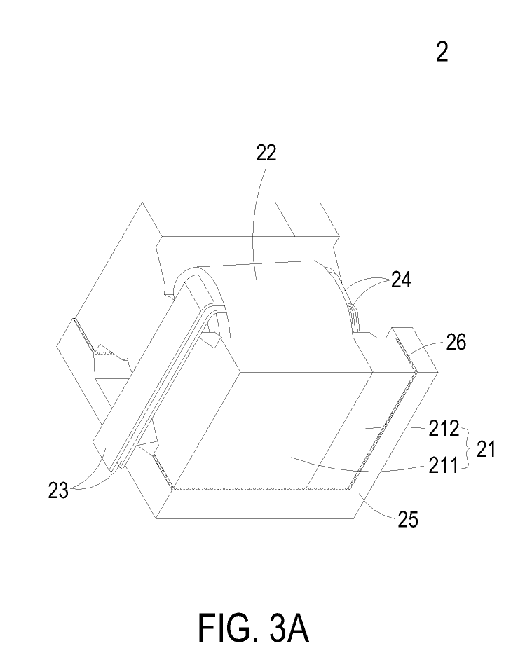

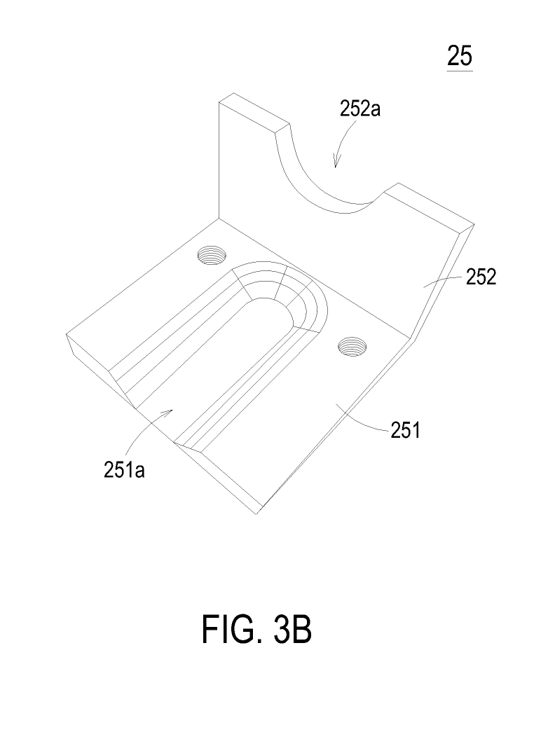

FIG. 3A is a schematic perspective view illustrating a magnetic device according to another embodiment of the present invention. FIG. 3B is a schematic perspective view illustrating the heat sink of the magnetic device of FIG. 3A. In comparison with FIG. 2A, transformer 2 of this embodiment further comprises a heat sink 25. The heat sink 25 comprises a base plate 251 and a lateral plate 252. The base plate 251 has a recess 251a for partially accommodating the plural conductive winding assemblies 22. The lateral plate 252 has a notch 252a. The terminals of first set of pins 23 or the second set of pins 24 are protruded outside the transformer 2 through the notch 252a. Moreover, an insulating bonding material 26 is coated on the base plate 251 and the lateral plate 252 of the heat sink 25. Via the insulating bonding material 26, the magnetic core assembly 21 is attached on the base plate 251 and the lateral plate 252 of the heat sink 25 so that the magnetic core assembly 21 is fixed on the heat sink 25. By the heat sink 25, the heat-dissipating efficiency of the transformer 2 is enhanced. An example of the insulating bonding material 26 includes but is not limited to an insulating adhesive.

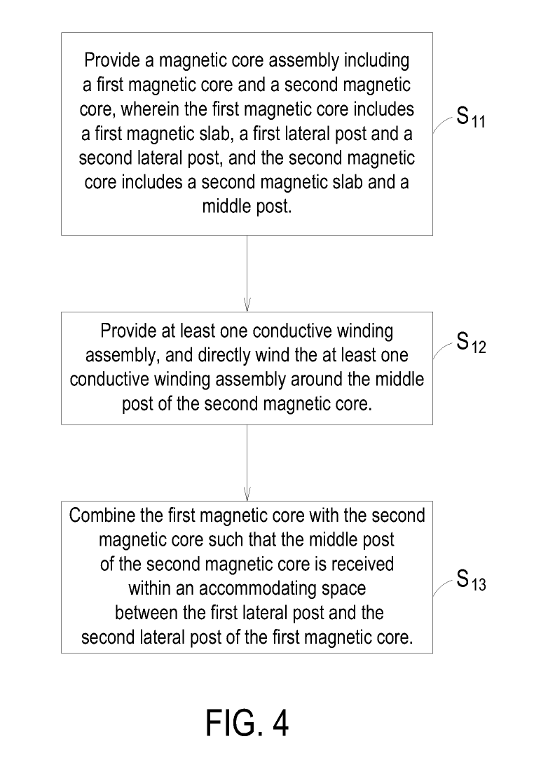

FIG. 4 is a flowchart illustrating a process of assembling a magnetic device according to an embodiment of the present invention. First of all, in the step S1, a magnetic core assembly 21 comprising a first magnetic core 211 and a second magnetic core 212 is provided, wherein the first magnetic core 211 comprises a first magnetic slab 211a, a first lateral post 211b and a second lateral post 211c, and the second magnetic core 212 comprises a second magnetic slab 212a and a middle post 212b. Then, in the step S2, at least one conductive winding assembly 22 is provided and directly wound around the middle post 212b of the second magnetic core 212. Afterwards, in the step S3, the first magnetic core 211 and the second magnetic core 212 are combined together such that the middle post 212b of the second magnetic core 212 is received within the accommodating space between the first lateral post 211b and the second lateral post 211c of the first magnetic core 211. Meanwhile, the transformer 2 is assembled.

In some embodiment, after the step S3 is performed, a heat sink 25 is provided, and the magnetic core assembly 21 is fixed on the heat sink 25 via an insulating bonding material 26. By the heat sink 25, the heat-dissipating efficiency of the transformer 2 is enhanced.

The above embodiments are illustrated by referring to a transformer as the magnetic device. Nevertheless, the magnetic device may be an inductor, wherein only a single conductive winding assembly is included in the inductor.

From the above description, since the magnetic device of the present invention uses a UT-type magnetic core assembly, the conductive winding assembly can be directly wound around the middle post of the T-shaped magnetic core by a winding machine. Since no bobbin is required, many benefits are achieved. For example, the magnetic device of the present invention has reduced fabricating cost, simplified assembling process, enhanced heat-dissipating efficiency, increased coil turn, and enhanced window utilization. Moreover, the magnetic device of the present invention may further include a heat sink. The magnetic core assembly is fixed on the heat sink in order to increase the heat-dissipating efficiency.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A magnetic device, comprising:
a magnetic core assembly comprising:
a first magnetic core comprising a first magnetic slab, a first lateral post and a second lateral post, wherein said first lateral post and said second lateral post are disposed on opposite sides of said first magnetic slab so that an accommodating space is defined by said first magnetic slab, said first lateral post and said second lateral post; and
a second magnetic core comprising a second magnetic slab and a middle post, wherein said middle post is attached on said second magnetic slab, and received within said accommodating space of said first magnetic core; and
at least one conductive winding assembly directly wound around said middle post of said second magnetic core.

2. The magnetic device according to claim 1, wherein said first magnetic slab, said first lateral post and said second lateral post of said first magnetic core are integrally formed, and said second magnetic slab and said middle post of said second magnetic core are integrally formed.

3. The magnetic device according to claim 1, wherein said magnetic device is an inductor.

4. The magnetic device according to claim 1, wherein said first magnetic core is U-shaped, and said second magnetic core is T-shaped.

5. The magnetic device according to claim 1, wherein said at least one conductive winding assembly is made of copper foil.

6. The magnetic device according to claim 1, further comprising a heat sink, wherein said magnetic core assembly is attached on said heat sink via an insulating bonding material.

7. The magnetic device according to claim 6, wherein said heat sink comprises a base plate and a lateral plate, and said base plate has a recess for partially accommodating said at least one conductive winding assembly.

8. The magnetic device according to claim 1, wherein said magnetic device is a transformer, and said at least one conductive winding assembly includes at least one primary conductive winding assembly and at least one secondary conductive winding assembly.

9. The magnetic device according to claim 8, further comprising a first set of pins and a second set of pins, which are respectively connected with said primary conductive winding assembly and said secondary conductive winding assembly.

10. The magnetic device according to claim 9, further comprising a heat sink, wherein said magnetic core assembly is attached on said heat sink via an insulating bonding material.

11. The magnetic device according to claim 10, wherein said heat sink comprises a base plate and a lateral plate, said base plate has a recess for partially accommodating said conductive winding assemblies, and said lateral plate has a notch for allowing the terminals of said first set of pins or said second set of pins to be protruded therethrough.

12. The magnetic device according to claim 8, wherein said primary conductive winding assembly and said secondary conductive winding assembly are insulated from each other and wound around said middle post of said second magnetic core.

13. The magnetic device according to claim 1, wherein said middle post of said second magnetic core is a cylindrical post

14. The magnetic device according to claim 1, wherein said first magnetic slab of said first magnetic core and said second magnetic slab of said second magnetic core are fan-shaped slabs.

15. The magnetic device according to claim 1, wherein after said first magnetic core and said second magnetic core are combined together, a free end surface of said middle post of said second magnetic core is separated from said first magnetic slab of said first magnetic core by an air gap distance, wherein said air gap distance is varied according to a length of said middle post.

16. The magnetic device according to claim 1, wherein after said first magnetic core and said second magnetic core are combined together, a free end surface of said middle post of said second magnetic core is contacted with said first magnetic slab of said first magnetic core, wherein no air gap is formed in said magnetic core assembly.

17. A process of assembling a magnetic device, said process comprising steps of:
(a) providing a magnetic core assembly comprising a first magnetic core and a second magnetic core, wherein said first magnetic core comprises a first magnetic slab, a first lateral post and a second lateral post, and said second magnetic core comprises a second magnetic slab and a middle post;
(b) providing at least one conductive winding assembly, and directly winding said at least one conductive winding assembly around said middle post of said second magnetic core; and
(c) combining said first magnetic core with said second magnetic core such that said middle post of said second magnetic core is received within an accommodating space between said first lateral post and said second lateral post of said first magnetic core.

18. The process according to claim 17, wherein said magnetic device is a transformer, and said at least one conductive winding assembly includes at least one primary conductive winding assembly and at least one secondary conductive winding assembly.

19. The process according to claim 17, further comprising a step of providing a heat sink, and fixing said magnetic core assembly on said heat sink via an insulating bonding material.
